(19) United States
(12) Patent Application Publication
(10) Pub. No.: US 2010/0024151 A1
(43) Pub. Date: Feb. 4, 2010

(54) FRAMELESS WINDSHIELD WIPER STRUCTURE

(76) Inventor: YUAN-CHIN KU, Sinjhuang City (TW)

Correspondence Address: LEONG C LEI, PMB # 1008, 1867 YGNACIO VALLEY ROAD, WALNUT CREEK, CA, 94598, US

(21) Appl. No.: 12/182,139

(22) Filed: Jul. 30, 2008

(51) Int. Cl. B60S 1/32

(52) U.S. Cl. 15/250.351

(57) ABSTRACT

A frameless windshield wiper includes a curved resilient metal plate, two flexible bars, two rubber back covers, a rubber wiping strip, and two end closure caps. The resilient metal plate is an elongate plate having an H-shape including a central connection section connecting between two strips defining therebetween elongate slits so that the metal plate assumes a fork-like configuration having opposite fork-like open ends. The central section is riveted to a coupler over which a plastic protective cap is fit. The flexible bars have upper and lower faces respectively forming upper and lower retainers to which the rubber back covers and the rubber wiping strip are respectively fit. The end caps are fit to opposite ends of the metal plates. Thus, an automobile windshield wiper that can be efficiently and easily assembled is provided.

### BACKGROUND OF THE INVENTION

(a) Technical Field of the Invention

The present invention relates to a windshield wiper, and in particular to a frameless windshield wiper that can be formed by efficient and easy assembling.

(b) Description of the Prior Art

A conventional automobile windshield wiper is illustrated in FIG. 7 of the attached drawings, comprising a plurality of pawl-like frames that are coupled to a rubber wiping strip 10. As shown in the drawings, the frames include a primary frame member 201, intermediate frame members 202, and minor frame members 203. A coupler is riveted to a central section of the primary frame member 201 and forms a pivot 301. Besides the pivot 301, the connection between the intermediate frame members 202 and the minor frame members 203 is also done by riveting 402. Apparently, the conventional windshield wiper has a complicated structure, which is comprised of numerous parts and requires tedious and delicate processing, making the assembling thereof complicated and inefficient and consuming a large amount of parts, and as a consequence, having a high cost.

Thus, the present invention is aimed to overcome such drawbacks by providing a frameless windshield wiper structure.

### SUMMARY OF THE INVENTION

The primary purpose of the present invention is to An objective of the present invention is to provide a frameless windshield wiper that comprises a curved resilient metal plate, two flexible bars, two rubber back covers, a rubber wiping strip, and two end closure caps. The structure is simplified and requires no conventional frames, so that riveting is eliminated and the assembling is efficient and easy by using fewer parts to ensure economic value.

Another objective of the present invention is to provide a frameless windshield wiper, which is easy to assemble and thus allows a user to conveniently replace a rubber wiping strip so that it ensures excellent environmental protection and good parts exchangeability.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a side-elevational view of a frameless windshield wiper constructed in accordance with the present invention;

FIG. 2 is a perspective view illustrating a coupler is detached from a metal plate of the windshield wiper in accordance with the present invention;

FIG. 3 is an exploded view of the frameless windshield wiper in accordance with the present invention;

FIG. 4 is also an exploded view of some constituent components of the frameless windshield wiper of the present invention;

FIG. 5 is a cross-sectional view taken along line A-A of FIG. 1;

FIG. 6 is a cross-sectional view taken along line B-B of FIG. 1; and

FIG. 7 is a perspective view of a conventional automobile windshield wiper.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The structural features of the present invention, as well as other functions and objectives, in accordance with the present invention will now be described with reference to a preferred embodiment illustrated in the attached drawings.

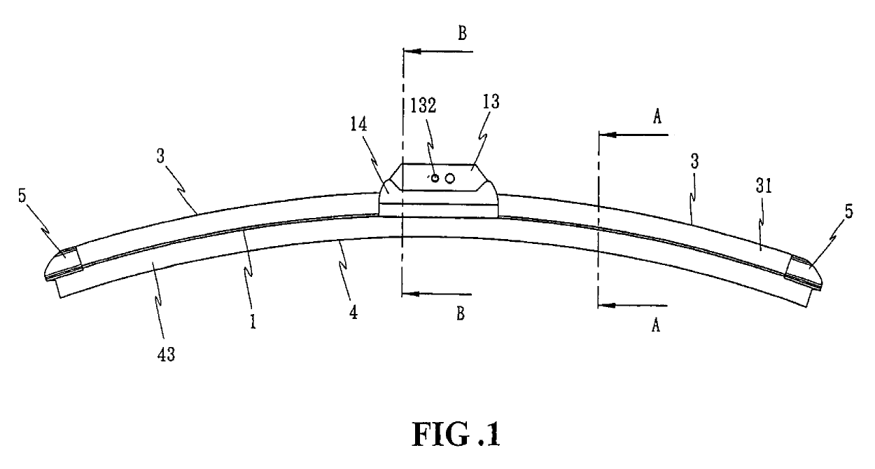

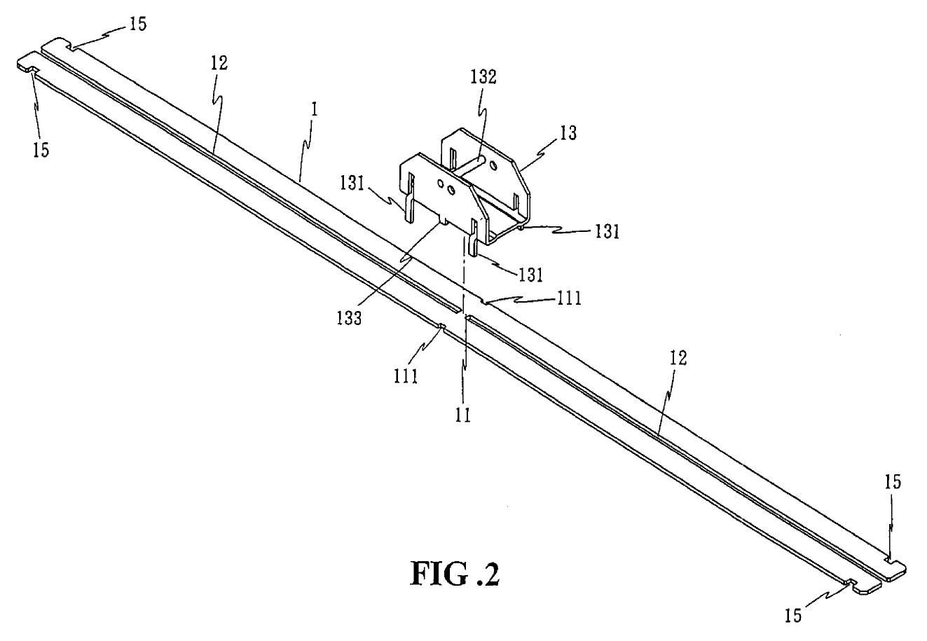

As shown in FIGS. 1 and 2, the present invention provides a frameless windshield wiper structure, which is comprised of a curved resilient metal plate 1, two flexible bars 2, two rubber back covers 3, a rubber wiping strip 4, and two end closures 5.

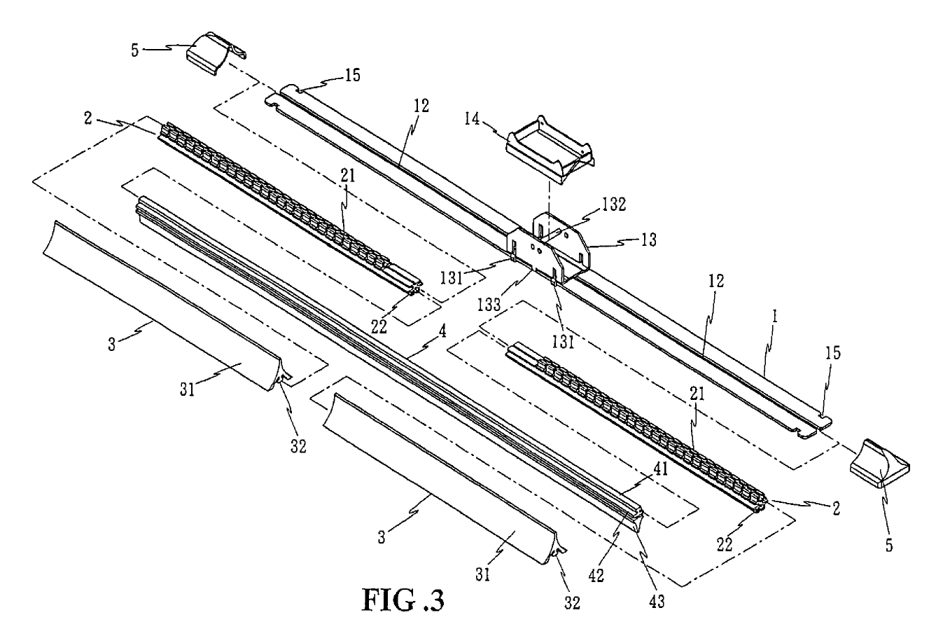

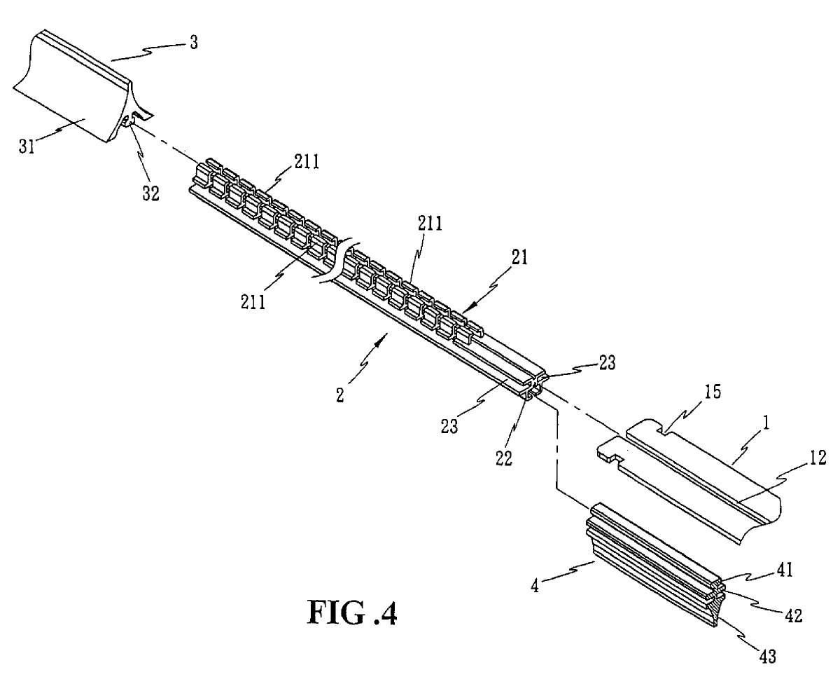

The resilient metal plate 1 is an elongate, curved member having an H-shape (as shown in FIG. 2) including a central connection section 11 connecting between two strips (not labeled) defining therebetween elongate slits 12 that are located on opposite sides of the central connection section 11 and respectively extending to opposite ends of the plate 1, so that the metal plate 1 assumes a configuration having opposite fork-like open ends. Opposite edges of the metal plate 1 form positioning notches 111 corresponding in position to the central connection section 11 for correctly positioning and jointing a rigid coupler 13. Aplastic protective cap 14 (see FIG. 3) is then fit over the coupler 13. It is noted that the metal plate 1 shown in FIGS. 2 and 3 is in a developed and flattened condition and the metal plate 1 is actually a shape-fixed curved plate as shown in FIG. 1. Retention notches 15 are respectively defined in opposite edges of the metal plate 1 at the opposite ends thereof.

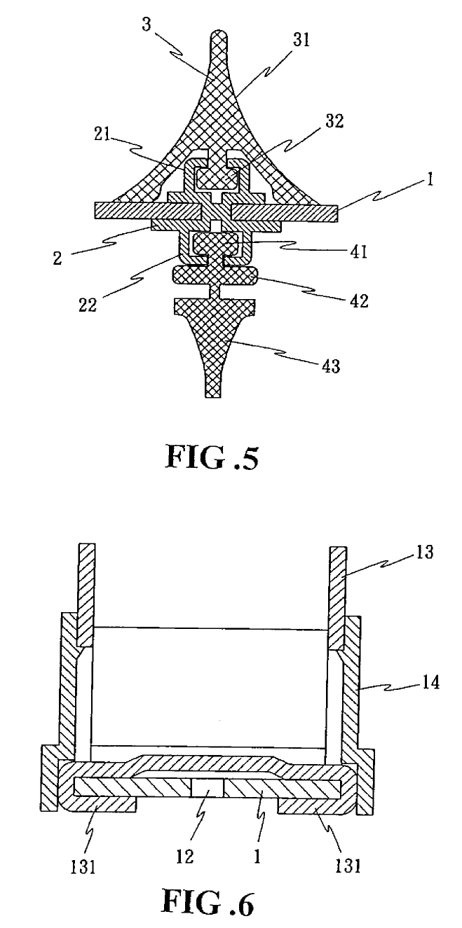

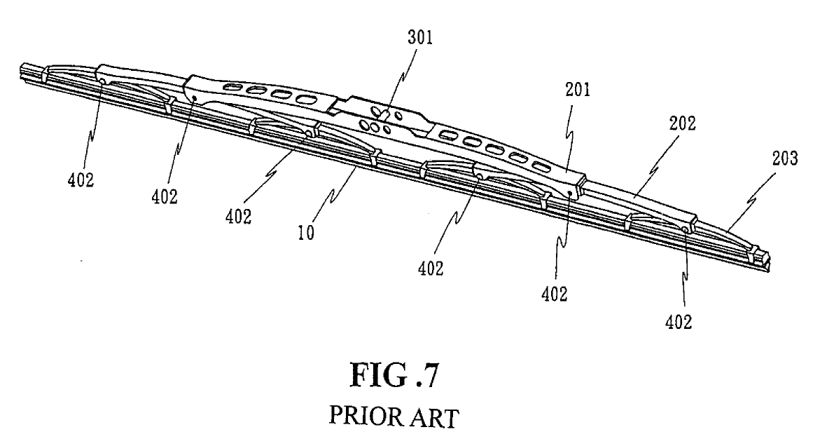

As shown in FIG. 2, the two flexible bars 2 are preferably made of plastics having flexible and bendable nature. Each flexible bar 2 has upper and lower faces respectively forming upper retainer 21 and lower retainer 22 and opposite side faces respectively forming fitting slots 23 to allow the flexible bar 2 to fit into the respective elongate slit 12 of the metal plate 1 with the fitting slots 23 snugly fit over upper and lower faces of the strips of the metal plate 1, as shown in FIG. 5. The upper retainer 21 is comprised of a plurality of pawls 211 that are lined up in two rows opposing each other to receive the rubber back covers 3, which will be further described, to fit therein. The lower retainer 22 is comprised of two opposite barbed ribs for receiving the rubber wiping strip 4 to fit and fix therein.

The two rubber back covers 3 each have two curved and continuous surfaces 31 that are opposite to each other and a bottom that forms a coupling projection rib 32, which can be a continuous rib or a plurality of spaced segments. The coupling projection rib 32 is fit into and thus retained in the upper retainer 21 of the respective flexible bar 2, whereby the rubber back covers 3 and the flexible bars 2 are respectively secured together, as shown in FIG. 5. The curved surfaces 31 can be identical to each other, or they can be made different from each other by having different curvatures, which can be arbitrarily varied. In the embodiment illustrated, the two curved surfaces 31 are of identical curvature.

The rubber wiping strip 4 is a rubber strip having a given lengthwise dimension having an upper portion forming a coextensive fitting rib 41, an intermediate portion forming a cushioning section 42 on opposite sides thereof and a lower portion forming a wiping blade 43 having a conic cross-section, whereby the upper fitting rib 41 is fit into and retained in the lower retainers 22 of both flexible bars 2 to securely fix the rubber wiping strip 4 to the two flexible bars 2, as shown in FIG. 5.

The end closures or caps 5 are respectively fit to the opposite ends of the metal plate 1 and engaging the retention notches 15 of the metal plate 1 to close the open ends of the metal plate 1.

With the above discussed components, a frameless windshield wiper can be formed by efficiently and easily assembling a metal plate 1, two flexible bars 2, two rubber back covers 3, a rubber wiping strip 4, and two end caps 5 for mounting to an automobile to carry out wiping-out of raindrops or water drops on the windshield. The assembling of the frameless windshield wiper can be done without using any rivet and the frameless windshield wiper has a simple structure, of which the rubber wiping strip 4 can be easily replaced. Thus, the frameless windshield wiper has a low part costs, making it satisfying the requirements of both economics and environmental protection.

As shown in FIG. 6, the assembling of a coupler 13 to the plastic protective cap 14 is illustrated. The coupler 13 has two fastening legs 131 formed on each of opposite edges of a bottom thereof for fastening to the metal plate 1, such as by means of riveting. The plastic protective cap 14, which is of a frame-like structure, is then fit over the coupler 13 and retained thereon. A pivot 132 is formed inside the coupler 13 for mounting the wiper to the automobile windshield. Two positioning lugs 133 are formed on the oppose edges of the bottom of the coupler 13 to engage the positioning notches 111 of the metal plate 1 for ensuring precise positioning therebetween before fastening (riveting) of the fastening legs 131 is carried out.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A frameless windshield wiper structure, which comprises a curved resilient metal plate, two flexible bars, two rubber back covers, a rubber wiping strip, and two end closure caps, characterized in that:
the resilient metal plate is a shaped, elongate curved plate having a central connection section connecting between two strips defining therebetween elongate slits that are located on opposite sides of the central connection section and respectively extending to opposite ends of the plate, so that the metal plate assumes a fork-like configuration having opposite fork-like open ends;
the two flexible bars have flexible and bendable nature, each flexible bar having upper and lower faces respectively forming upper retainer and lower retainer and opposite side faces respectively forming fitting slots to allow the flexible bar to fit into the respective elongate slit of the metal plate with the fitting slots snugly fit over upper and lower faces of the strips of the metal plate;
the two rubber back covers each have two curved and continuous surfaces that are opposite to each other and a bottom that forms a coupling projection rib, which is fit into and thus retained in the upper retainer of the respective flexible bar, whereby the rubber back covers and the flexible bars are respectively secured together;
the rubber wiping strip is a rubber strip having a given lengthwise dimension and is fit into and retained in the lower retainers of the flexible bars; and
the end closure caps are respectively fit to the opposite open ends of the metal plate to close the open ends of the metal plate;
wherein by efficiently and easily assembling the metal plate, the flexible bars, the rubber back covers, the rubber wiping strip, and the end caps, a frameless windshield wiper is formed.

2. The frameless windshield wiper structure as claimed in claim 1, wherein the central connection section of the metal plate is coupled with a rigid coupler and wherein a plastic protective cap 14 is fit over the coupler.

3. The frameless windshield wiper structure as claimed in claim 1, wherein the metal plate forms in opposite edges thereof retention notches at opposite ends thereof.

4. The frameless windshield wiper structure as claimed in claim 1, wherein the flexible bars are made of plastics.

5. The frameless windshield wiper structure as claimed in claim 1, wherein the upper retainer of each flexible bar comprises a plurality of pawls that are lined up in rows opposing each other.

6. The frameless windshield wiper structure as claimed in claim 1, wherein the lower retainer of each flexible bar comprises two opposite barbed ribs.

7. The frameless windshield wiper structure as claimed in claim 1, wherein the coupling projection rib of the rubber back cover is continuous rib or is comprised of a plurality of spaced segments.

8. The frameless windshield wiper structure as claimed in claim 1, wherein the opposite curved surfaces of the rubber back cover are of identical or different curvatures.

9. The frameless windshield wiper structure as claimed in claim 1, wherein the rubber wiping strip has an upper portion forming a fitting rib, an intermediate portion forming a cushioning section and a lower portion forming a wiping blade having a conic cross-section.
